(19) United States
(12) Patent Application Publication
(10) Pub. No.: US 2005/0041691 A1
(43) Pub. Date: Feb. 24, 2005

(54) Apparatus and methods for providing synchronous digital data transfer over an ethernet

(76) Inventors: Eli Laufer, Woodland Hills, CA (US); Zvi Regev, West Hills, CA (US)

Correspondence Address: GARY L. SHAFFER, 901 BANKS PLACE, ALEXANDRIA, VA, 22312, US

(21) Appl. No.: 10/627,993

(22) Filed: Jul. 28, 2003

(51) Int. Cl. H04J 3/00

(52) U.S. Cl. 370/503

(57) ABSTRACT

Systems, means and methods for reliably transporting Time Domain Multiplexing (TDM) data over one or more Ethernet installations or networks are provided. The present systems, means and methods provide coordinated frequency multipliers and dividers that are adapted and arranged with phase locked loops such that the respective clock functions of data can be recovered to the extent necessary to assure dependable communication of TDM data over one or more Ethernet networks. Advantageously, the original TDM clock frequency is restored.

### FIELD OF THE INVENTION

The present invention relates generally to synchronous digital data transfer and, more particularly, provides means and methods for communicating time division multiplexed (synchronous) data over one or more Ethernet networks.

### BACKGROUND OF THE INVENTION

Several architectures are employed for communications systems including, for example, rings and buses. Among the most popular communications architecture is the Ethernet, which is a bus-based Local Area network (LAN). LAN communications are generally limited by distance. The distance for Ethernet communications can be extended by using, for example, one or more Wide Area Networks (WANs) to connect two or more Ethernet LANs. The Ethernet LANs are connected to a WAN via, for example, routers, bridges and/or brouters. Typically, a wide area network, or WAN is a computer and voice network that provides communications services to a geographic area bigger than a city or metropolitan area, and thus is larger than the geographic area served by a LAN (Local Area Network) or a Metropolitan Area Network (MAN). A WAN is therefore a data communications network that may serve an area of hundreds of thousands of square miles. Examples of WAN's include national telephone networks and public and private packet-switching networks

In Time Division Multiplexing (TDM) the bandwidth is broken into a plurality of time slots that are allocated on some basis to users of the network. Each time slot typically uses the entire bandwidth but for a very short/limited period of time. There is usually a guard band between time slots allowing for a very small amount of time between time slots.

Synchronous TDM signals have been used primarily by the communications networks as a means of wide-band communication. In a TDM system, several lower frequency signals are multiplexed into one wide-band signal, transported as a wide-band signal over the communication media, and then de-multiplexed back to a number of lower frequency signals. Since the multiplexing and the de-multiplexing are performed in locations that are far apart, it is mandatory the both ends of the wide-band communications line use exactly the same clock frequency in the multiplexing and de-multiplexing process. Hence, there are very strict requirements on the clock precision and jitter in TDM communications.

In contrast, data transported over an Ethernet is packetized. That is, the data is placed in packets and may be communicated to a remote node in the network using a datagram service or, for example, using TCP/IP protocol, sent over the network to an addressee somewhere in the network where the packets are re-assembled into the proper order. In a datagram service the packets may be acknowledged by the next node in the transmission but not be subject to end-to-end acknowledgement. A node is a point of connection into a network, and is synonymous with site or location. Using some protocols, such as TCP/IP, the protocol handles all of the “handshaking” and provides end-to-end acknowledgement of the packet reception. TCP/IP provides other services including flow control, security and the like.

In some installations, there may be a plurality of servers connected to each other via an Ethernet. Each server may support a plurality of clients connected to a server by another Ethernet. The data is transmitted to an addressee as packets of data using the available bandwidth of the Ethernet. In Ethernet communications there are no multiplexers or de-multiplexers. Instead, in an Ethernet system, data is combined into packets that are transmitted over the communication media, such that every packet carries its own destination address. Ethernet data is sent in packets with known minimum gaps between any two adjacent packets. Therefore, the requirements for an Ethernet clock are lax compared with the comparable requirements for TDM clocks, since the inter-packet gap may be used as an elasticity cushion, to “catch-up” with any differences in transmission speed. As an example, if the nominal clock frequency for Fast-Ethernet is 125.000 MHz, it can actually range anywhere between 124.975 MHz to 125.025 MHz, or +/− 200 ppm.

These differences between TDM and Ethernet systems are particularly significant when the combination of both systems are attempted by means of conventional equipment or methods. Packets of data transmitted over an Ethernet installation using a transmission scheme that is typically asynchronous do not generally mesh well with TDM data transmitted in time slots.

With Ethernet becoming the most popular communications media, and with the majority of all network installations operating using the Ethernet, it is now critical to find new reliable ways of transporting conventional synchronous TDM data over Ethernet installations. The biggest challenge in sending TDM traffic over the Ethernet is to reconstruct the TDM clock on the receiver side and maintain the required clock jitter and accuracy requirements.

Several methods have been employed in prior art to accomplish transmission of TDM data over the Ethernet. In one such method, shown in FIG. 1, the TDM (serial synchronous) data 105 is stored temporarily and formed into packets by the synchronous data de-serializer packetizer 110, which are then transported as regular payload over the Ethernet network. At the receiver, a synchronous data serializer 115 outputs TDM (serial synchronous) data 120 and a synchronous clock 125. Because of the differences in requirements and frequencies for clocks for the TDM signals and the clocks for Ethernet, various methods need to be employed to rectify the mismatch. One such method employs the addition/deletion of bits on the receiver side to compensate for the difference in the number of clock pulses over a period between the transmission side and the receiving side. This method, however, requires that the Ethernet clock will have the same strict jitter requirements as the TDM clock. In a different method, TDM data is inserted into the gaps between regular Ethernet packets, and thus does not affect the data bandwidth of the Ethernet data.

Restoring the original TDM clock, with its low jitter requirements is still a problem. In one prior art method, a low frequency reference clock is sent as data over the Ethernet network. In a different method, the TDM clock is regenerated on the receiving side by deriving the clock from the received data, and synchronizing it to a global precise clock (Stratum clock) derived from an atomic time standard, such as the GPS system. Nonetheless, these known methods and systems do not perform consistently well enough to provide dependable data communication services.

### SUMMARY OF THE INVENTION

In the present invention, synchronous TDM data is transported over Ethernet installations while preserving the original TDM clock properties. TDM and Ethernet clock properties are preserved using frequency multiplication, frequency division and phase locked loops (PLLs). Advantageously, the invention provides means and methods for transmitting TDM data over one or more Ethernet networks and provides systems of reception modules, transmission modules, transceiver modules, and operational pairs of such modules which employ phase locked loops to dependably effect such data transfer.

The means and methods of the present invention include reception modules, transmission modules, operational pairs of one of each of such modules, and transceiver modules, as well as a myriad of ways of interconnecting and interrelating such modules so that TDM data can be efficiently communicated over one or more interrelated Ethernet networks or over Ethernet networks interrelated via one or more wide area networks (WAN's). In the context of the invention, the term operational pair refers to any operationally coupled pair, for example, one transmission module and one reception module. Alternatively stated, a switch adapted for transmitting data may be coupled operationally to a switch adapted to receive that data, where a switch is a device or method for coupling a selected input to a selected output. The coupling may or may not be a one-to-one mapping . For example, a transmission module in a first location and a reception module in a distant location would be an operational pair when they are coupled such that data transmitted from the transmission module is received by the reception module. Another example of an operational pair is a transmission module co-located with a reception module to form a transceiver module for sending and receiving data over corresponding channels.

As one of skill in the art will comprehend from the specification and claims, there are a significant number of variations and permutations of each of the types and classes of modules within the scope of the invention. FIG. 2(A) illustrates an exemplary embodiment including operational units at node/site location A and at node/site location B. In this exemplary embodiment, transmission module 1005 receives data, for example, from a host computer (not shown) via line 1025. The invention is practiced in transmission module 1005 as further described below and the data is transmitted over Ethernet communications medium 1030 to reception module 1020. The invention is practiced in reception module 1020 as further described below and the received data is forwarded to, for example, a host computer (not shown) via line 1035. Similar functionality is present with respect to line 1040, transmission module 1010, Ethernet communications medium 1045, reception module 1015 and line 1050.

It should be further understood that Ethernet communications medium 1030 and 1045 may be a single Ethernet communications medium or a plurality of Ethernet communications media. It should also be understood that transmission module 1005 may physically be combined with reception module 1015 to form transceiver module 1055 at node/site/location A. Similarly, transmission module 1010 may be combined with reception module 1020 to form transceiver module 1060 at node/site/location B. Transmission module 1005 and reception module 1020 may be considered to be an operational pair. Similarly, transmission module 1010 and reception module 1015 may also be considered an operational pair. It would be similarly understood that transceiver 1055 at site A and transceiver 1060 at site B may be considered to be an operational pair.

Advantageously, the invention provides a transmission module for transmitting Time Division Multiplexed (“TDM”) data over an Ethernet network, the transmission module comprising i) a TDM data converter/encapsulator for receiving TDM data from a source; ii) a synchronous clock signal associated with the TDM data; iii) a clock frequency multiplier coupled to the TDM data converter/encapsulator; iv) a switch for receiving converted/encapsulated TDM data and for receiving a master clock signal; and v) wherein the master clock signal is generated by the clock frequency multiplier, the master clock signal is related to the synchronous clock signal associated with the TDM data; and wherein the switch is coupled to both the TDM data converter/encapsulator, and the clock frequency multiplier.

Preferably, a switch in a transmission module of the invention comprises at least two ports, the master clock signal governs and synchronizes the timing of data transmissions from the switch. A transmission module of the invention includes a clock frequency multiplier, wherein the clock frequency multiplier has an input frequency, an output frequency, and a frequency multiplication ratio, which is the ratio of the input and output frequencies, and wherein the clock frequency multiplier is adapted and arranged such that the output frequency is a multiple of the input frequency. Thus, the output frequency of the transmission module equals the master clock frequency. An advantage of the invention is that one or more of the input frequency, the output frequency, and the frequency multiplication ratio are digitally programmable.

In one preferred embodiment, a reception module for receiving converted/ encapsulated Time Division Multiplexed (“TDM”) data over an Ethernet network includes i) a switch for receiving the converted/encapsulated TDM data from the Ethernet network over at least one Ethernet communications medium; ii) a TDM decapsulator coupled to the switch; iii) a clock recovery phase locked loop (“PLL”) for receiving a frequency, the PLL being adapted to adjust a phase of the frequency to provide a phase-adjusted frequency; and iv) a clock frequency divider coupled to the PLL for dividing the phase-adjusted frequency to recover a TDM clock signal associated with the TDM data. In the context of the invention, a phase locked loop is a mechanism whereby timing information is transferred within a data stream and the receiver derives the signal element timing by locking its local clock source to the received timing information. As an additional aspect of the invention, the TDM decapsulator is both coupled to the clock frequency divider, and adapted and arranged to serialize the received converted/ encapsulated TDM data by means of the recovered TDM clock signal.

In a reception module according to the invention, the converted/encapsulated TDM data is received as Ethernet packets and, after being received, the Ethernet packets are converted into at least one TDM protocol data stream. A switch according to the invention comprises at least two ports for inputting and outputting the data stream. In an important aspect, the module further includes a master clock signal which is adapted and arranged to govern and synchronize the timing of data received via the switch. In another aspect, the clock recovery PLL and a clock frequency divider extracts a high frequency clock signal from the received Ethernet data and the extracted frequency clock signal therefore equals the data bit rate of the received TDM data.

In accordance with other aspects of a reception module of the invention, the clock frequency divider has an input frequency, an output frequency, and a frequency division ratio, which is the ratio of the input and output frequencies, the divider being adapted and arranged such that the output frequency is a fraction of the input frequency. Thus, the clock frequency divider output frequency equals the received TDM clock signal. Advantageously, each of the input frequency, the output frequency, and the frequency division ratio are programmable digitally, or otherwise, to thereby render the invention adaptable to numerous frequencies, bandwidths and permutations.

For example, one of the numerous embodiments of the present invention adapts and arranges transmission modules and reception modules to form one or more systems or networks for communicating Time Division Multiplexed data over an Ethernet network. One preferred embodiment of such a system comprises at least one transmission module and at least one reception module, wherein the at least one transmission module comprises a TDM data converter/encapsulator for receiving TDM. data from a source, a synchronous clock signal associated with the TDM data, a clock frequency multiplier coupled to the TDM data converter/encapsulator, and a first, or transmission module, a first switch for receiving converted/encapsulated TDM data and for receiving a master clock signal wherein the master clock signal is generated by the clock frequency multiplier, the master clock signal being related to the synchronous clock signal associated with the TDM data, and wherein the first switch is coupled to both the TDM data converter/encapsulator, and the clock frequency multiplier. In this embodiment, at least one reception module is provided, the reception module preferably comprising a second, or reception module, a second switch for receiving converted/encapsulated TDM data from the Ethernet network over at least one Ethernet communications medium, a TDM decapsulator coupled to the second switch, a clock recovery phase-locked loop (“PLL”) for receiving a frequency, the PLL being adapted to adjust a phase of the frequency to provide a phase-adjusted frequency, and a clock frequency divider coupled to the PLL for dividing the phase-adjusted frequency to recover a TDM clock signal associated with the TDM data, wherein the TDM decapsulator is coupled to the clock frequency divider, and adapted and arranged to serialize the received converted/ encapsulated TDM data by means of the recovered TDM clock signal.

In such an embodiment of a system according to the invention, a first transmission module at node A and a first reception module at node B are located distant from one another and are adapted and arranged to function as a first operational pair for communicating data in a first direction. In accordance with further objects of the invention, one or a plurality of additional operational pairs, for example a second reception module at node A and a second transmission module at node B, are provided and are operationally adapted and arranged to fiction as a second operational pair, and the first and second operational pairs are adapted and arranged to function as a bi-directional communications system for communicating in a first direction and in a second direction, the second direction being opposite the first direction.

Thus, unidirectional operational pairs according to the invention have reception modules located distant from their corresponding transmission modules, and two operational pairs are coupled such that bi-directional communication is effected between two points which may be quite distant from one another. In the context of the invention, “distant” means whatever distance over which it is necessary, preferred or efficient, such as hundreds or thousands of meters, or hundreds or thousands of kilometers, to employ the present invention to transmit, exchange or transfer data or data streams. The present invention is advantageously suited for long-distance communications especially when a plurality of systems of operational pairs are implemented in accordance with the present description, and those systems are further connected via one or ore wide area networks (WANS).

The invention also provides one or more transceiver modules, each transceiver module including at least one transmission module coupled and co-located with at least one reception module. A transceiver module according to the invention thus differs from an operational pair described above in that it functions in the same location as two halves of corresponding operational pairs, that is, at least one reception module and at least one transmission module are co-located to form a transceiver module. Thus, bi-directional communication is effected when one first reception module and one second transmission module are co-located with one another to form a first transceiver module at point A, and the corresponding second reception module and corresponding first transmission module are co-located with one another to form a second transceiver module at point B. In a further significant aspect, a plurality of transceiver modules may be operationally coupled, adapted and arranged to form a larger system or network.

Preferably, a transmission module of a system according to the invention comprises at least two ports, and the master clock governs and synchronizes the timing of data transmissions from each of the ports. Also preferably, a reception module of a system according to the invention comprises at least two ports, and the master clock governs and synchronizes timing of data transmissions from the ports. Additional aspects of one or more systems according to the invention include a clock frequency multiplier wherein the clock frequency multiplier has an input frequency, an output frequency, and a frequency multiplication ratio, which is the ratio of the input and output frequencies, and wherein the multiplier is adapted and arranged such that the output frequency is a multiple of the input frequency and wherein one or more of the input frequency, the output frequency, and the frequency multiplication ratio are programmable digitally or otherwise. Systems of the invention also include adaptations wherein converted/encapsulated TDM data is received as Ethernet packets and the Ethernet packets are converted into at least one TDM protocol data stream by a TDM decapsulator, and wherein a clock recovery PLL extracts a high frequency clock signal from the received Ethernet data, and the extracted frequency clock equals the data bit rate of the received TDM data, and wherein a provided clock frequency divider has an input frequency, an output frequency, and a frequency division ratio which is the ratio of the input and output frequencies, and wherein the clock frequency divider is adapted and arranged such that the output frequency is a fraction of the input frequency.

The invention also comprehends methods for effecting steps, acts or actions to accomplish the transfer, transmission or exchange of data, originating or existing as TDM data, from or between one or more points. Thus, one preferred method for transmitting Time Division Multiplexed (“TDM”) data over an Ethernet network comprises the acts of i) receiving the TDM data and a synchronous clock associated with the TDM data from a source by means of a TDM data converter/encapsulator; ii) generating a master clock signal related to the synchronous clock signal; iii) packetizing the TDM data, iv) forwarding the packetized data and the master clock signal to a switch; and v) switching the packetized TDM data onto at least one Ethernet communications media of an Ethernet network. In this embodiment of methods of the invention, the actions are performed such that the master clock signal is generated by a clock frequency multiplier, and the master clock is related to the synchronous clock signal associated with the TDM data, and wherein the switching is effected by a switch. the switch being coupled to both the TDM data converter/encapsulator, and to the clock frequency multiplier. In some embodiments of methods of the invention, acts iii and iv are performed concurrently. In other embodiments, they are performed sequentially.

Significant aspects of methods of the invention include a switch, wherein the switch comprises at least two ports, and wherein a master clock signal governs and synchronizes the timing of data transmissions from the switch, wherein the clock frequency multiplier has an input frequency, an output frequency, and a frequency multiplication ratio, which is equal to the ratio of the input and output frequencies, and wherein the clock frequency multiplier is adapted and arranged such that the output frequency is a multiple of the input frequency, wherein the output frequency equals the master clock frequency as well as embodiments wherein one or more of the input frequency, the output frequency, and the frequency multiplication ratio are programmable digitally or otherwise.

The invention comprehends also a method or methods for receiving converted encapsulated Time Division Multiplexed (“TDM”) data over an Ethernet network comprising the acts of i) receiving the converted/encapsulated TDM data from the Ethernet network by means of a switch; ii) decapsulating the TDM data by means of a TDM decapsulator coupled to the switch; iii) receiving a clock frequency signal by means of a clock recovery PLL; iv) adjusting the clock frequency signal by means of the clock recovery PLL to provide a phase-adjusted clock frequency, the PLL being adapted to adjust a phase of the clock frequency signal; and v) dividing the phase-adjusted clock frequency by means of a clock frequency divider coupled to the PLL to recover a TDM clock signal associated with the TDM data. Preferably, the methods for receiving include the provision of a TDM decapsulator, wherein the TDM decapsulator is coupled to the clock frequency divider, and adapted and arranged to serialize the received converted/encapsulated TDM data by means of the recovered TDM clock signal.

The present methods of receiving data include wherein the converted/encapsulated TDM data is received as Ethernet packets and the Ethernet packets are converted into at least one TDM protocol data stream. In some preferred embodiments of methods of the invention, acts iii and iv are performed concurrently. In other preferred embodiments, they are performed sequentially. Significant aspects of methods of the invention for receiving converted/ encapsulated Time Division Multiplexed (“TDM”) data over an Ethernet network include those where the switch comprises at least two ports, and wherein the master clock signal governs and synchronizes the timing of data transmissions from the switch, wherein the clock frequency multiplier has an input frequency, an output frequency, and a frequency multiplication ratio which is equal to the ratio of the input and output frequencies, and wherein the multiplier is adapted and arranged such that the output frequency is a multiple of the input frequency, wherein the output frequency equals the master clock frequency as well as embodiments wherein one or more of the input frequency, the output frequency, and the frequency multiplication ratio are programmable digitally or otherwise.

The present invention also provides a method for communicating Time Division Multiplexed data over an Ethernet network, the method comprising the acts of i) providing at least two transceiver modules, and ii) operationally coupling, adapting or arranging the at least two transceiver modules to effect communication therebetween. Preferably, each of the transceiver modules is adapted, constructed and arranged as described hereinabove, and the method may include the further acts of iii) providing more than two of the transceiver modules, and iv) operationally coupling, adapting or arranging the more than two transceiver modules to effect communication between or among any two or more of the modules.

As a further advantage, the present invention provides a network comprising a first Ethernet network and a second Ethernet network, wherein each of the Ethernet networks is adapted for bi-directional communications between a transmission module and a reception module of each of the Ethernet networks, at least one wide area network (WAN) adapted for long-distance bi-directional communications, the wide area network being interposed between the first and the second Ethernet networks, and a plurality of operational pairs of switches adapted for performing clock recovery functions and data transfer functions between pairs of Ethernet networks, wherein the first Ethernet network and the second Ethernet network are adapted to communicate with one another through the wide area network. In some preferred embodiments, each of the first and second Ethernet networks comprises at least one transmission module, and at least one reception wherein each of the Ethernet transmission modules comprises i) a TDM data converter/encapsulator for receiving TDM data from a source, i) a synchronous clock signal associated with the TDM data, iii) a clock frequency multiplier coupled to the TDM data converter/ encapsulator; and iv) a transmission module switch for receiving converted/encapsulated TDM data and for receiving a master clock signal, wherein the master clock signal is generated by the clock frequency multiplier, the master clock signal being related to the synchronous clock signal associated with the TDM data, and wherein the transmission module switch is coupled to both the TDM data converter/encapsulator, and the clock frequency multiplier.

As in other embodiments of the invention, each of the Ethernet reception modules preferably comprises v) a reception module switch for receiving converted/encapsulated TDM data from the Ethernet network over at least one Ethernet communications medium, vi) a TDM decapsulator coupled to the second switch, vii) a clock recovery PLL for receiving a frequency, the PLL being adapted to adjust a phase of the frequency to provide a phase-adjusted frequency; and viii) a clock frequency divider coupled to the PLL for dividing the phase-adjusted frequency to recover a TDM clock signal associated with the TDM data; wherein the TDM decapsulator is coupled to the clock frequency divider, and adapted and arranged to serialize the received converted/encapsulated TDM data by means of the recovered TDM clock signal.

In accordance with other key aspects of the invention, each of the operational pairs of switches of the network is adapted and configured between one of the Ethernet networks and the WAN to function as a transceiver switch pair, and the at least one Ethernet reception module and the at least one Ethernet transmission module are adapted or configured to form a single operational transceiver module. Preferably, a first pair of the plurality of operational pairs of switches of the network is configured as a transmission switch pair such that a first switch of the transmission switch pair accepts encapsulated Ethernet data from one of the at least two Ethernet networks for transmission to a second switch of the transmission switch pair, and the second switch of the transmission switch pair transmits the encapsulated Ethernet data and interfaces with the WAN to transmit the encapsulated Ethernet data over the WAN to a second pair of the plurality of pairs of switches, and wherein the second pair of the plurality of switches is configured as a reception switch pair such that, a first switch of the reception switch pair receives the encapsulated Ethernet data via the WAN, and a second switch of the reception. switch pair receives the encapsulated Ethernet data from the first switch of the reception switch pair for forwarding and distribution over a second of the at least two Ethernet networks. Also, in accordance with additional advantageous aspects of the present invention, the first pair of the plurality of operational pairs of switches is configured both as a transmission switch pair and a reception switch pair to thus form a transceiver switch pair adapted and arranged to be suitable for bi-directional communications. Moreover, the operational pairs of switches can be implemented, that is, adapted and configured to form an adapted network switch.

The present invention also provides methods, including a method for communicating TDM data over long distances comprising the acts of i) providing at least a first Ethernet network and a second Ethernet network, wherein each of the Ethernet networks is adapted. for bi-directional communications between a transmission module and a reception module of each of the Ethernet networks, ii) providing at least one wide area network (WAN) adapted for long-distance bidirectional communications, the wide area network being interposed between the first and the second Ethernet networks, and iii) providing a plurality of operational pairs of switches adapted for performing clock recovery functions and data transfer functions between pairs of Ethernet networks, wherein the first Ethernet network and the second Ethernet network are adapted to communicate with one another through the wide area network. Consonant with this method, a first pair of the plurality of operational pairs of switches preferably is configured as a transmission switch pair such that a first switch of the transmission switch pair accepts encapsulated Ethernet data from one of the at least two Ethernet networks for transmission to a second switch of the transmission switch pair, and the second switch of the transmission switch pair transmits the encapsulated Ethernet data and interfaces with the WAN to transmit the encapsulated Ethernet data over the WAN to a second pair of the plurality of pairs of switches, and wherein the second pair of the plurality of switches is configured as a reception switch pair such that, a first switch of the reception switch pair receives the encapsulated Ethernet data via the WAN, and a second switch of the reception switch pair receives the encapsulated Ethernet data from the first switch of the reception switch pair for forwarding and distribution over a second of the at least two Ethernet networks. The method advantageously may be effected over a plurality of Ethernet networks and by means of a plurality of the operational switch pairs.

An additional method of the invention is that for communicating TDM data over long distances, comprising the acts of: i) providing TDM data and a synchronized clock signal from a first TDM network to a first Ethernet network; ii) encapsulating the TDM data; iii) generating a master clock signal related to the synchronous clock signal by means of a frequency multiplier; iv) forwarding the encapsulated TDM data to a first operational pair; v) forwarding the encapsulated TDM data to a second operational switch pair via a wide area network; vi) receiving the encapsulated TDM data at a destination in a second Ethernet network; vii) decapsulating the received encapsulated TDM data; viii) recovering and phase-adjusting a clock signal from the decapsulated TDM data using a phase-locked loop and a frequency divider; ix) serializing the decapsulated TDM data; and x) forwarding the serialized TDM data and the recovered clock signal to a second TDM network.

An adapted network switch according to the invention preferably comprises a system clock generator; a control, processing and data switching matrix coupled to memory, the control, processing and data switching matrix further coupled to the system clock generator; a plurality of data communication ports coupled to the system clock generator, each of the ports further coupled to the control, processing and data switching matrix via bidirectional data signals; and a clock switching matrix coupled to the control, processing and data switching matrix via a control signal, the clock switching matrix configured such that a clock used in transmitting data from the adapted network switch is the clock recovered from the data when the data was received at the data communications port.

### BRIEF DESCRIPTION OF THE DRAWINGS

The invention can best be described with reference to the detailed description and the following figures where:

FIG. 1 is an embodiment of prior art TDM signals over an Ethernet installation;

FIG. 2(a) illustrates an exemplary embodiment including operational units at node/site location A and at node/site location B.

FIG. 2(b) is an exemplary unidirectional embodiment of the present invention of TDM signals over an Ethernet;

FIG. 3 is an exemplary bidirectional embodiment of the present invention of TDM signals over an Ethernet;

FIG. 4 is an exemplary embodiment of a frequency multiplier/divider used in the present invention;

FIG. 5 is an exemplary embodiment of a Digital Frequency Divider used in the present invention;

FIG. 6 is an exemplary embodiment of a Phase Locked Loop circuit used in the present invention;

FIG. 7 is a conceptual view of a plurality of Ethernets connected via a plurality of WANs;

FIG. 8 is a block diagram of the present invention used with network switching devices adapted to perform clock recovery functions between Ethernets; and

FIG. 9 is a block diagram of an exemplary network switching device of the present invention.

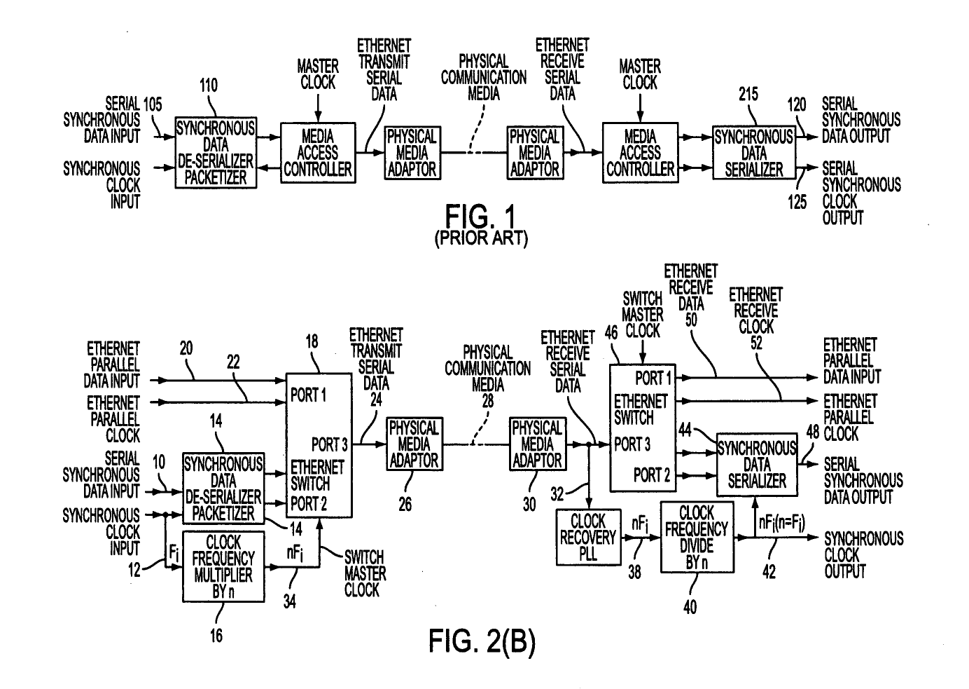

### DETAILED DESCRIPTION OF THE INVENTION

One typical TDM. bandwidth is known as T1, and is widely used by telecommunications providers. The clock rate of T1 is 1.544 MHz. The ratio between the T1 clock and the Fast-Ethernet clock is 80.9585. If the T1 clock frequency is divided by 193, and then multiplied by 15625, the result is 125.000 MHz. If the T1 clock frequency is multiplied by 80.96, the frequency of resulting signal is 125.00224 MHz, well within the clock frequency specifications for Fast-Ethernet. It therefore follows logically that the clock for an Ethernet link may be derived, by way of multiplication, from the clock of a TDM signal such as T1.

The clock frequency of the Fast-Ethernet can likewise be divided to generate a T1 clock. In a process that is exactly the reverse of the frequency multiplication described above, the Ethernet clock frequency of 125.000 MHz can be divided by 15625, and then multiplied by 193, to yield a 1.544 MHz T1 clock. The Ethernet clock frequency of 125.00224 MHz can be divided by 80.96 to produce a T1 clock at 1.544 MHz.

FIG. 2(A) illustrates an exemplary embodiment including operational units at node/site location A and at node/site location B. In this exemplary embodiment, transmission module 1005 receives data, for example, from a host computer (not shown) via line 1025. The invention is practiced in transmission module 1005 as further described below and the data is transmitted over Ethernet communications medium 1030 to reception module 1020. The invention is practiced in reception module 1020 as further described below and the received data is forwarded to, for example, a host computer (not shown) via line 1035. Similar functionality is present with respect to line 1040, transmission module 1010, Ethernet communications medium 1045, reception module 1015 and line 1050. It should be further understood that Ethernet communications medium 1030 and 1045 may be a single Ethernet communications medium or a plurality of Ethernet communications media. It should also be understood that transmission module 1005 may physically be combined with reception module 1015 to form transceiver module 1055 at node/site/location A. Similarly, transmission module 1010 may be combined with reception module 1020 to form transceiver module 1060 at node/site/location B. Transmission module 1005 and reception module 1020 may be considered to be an operational pair. Similarly, transmission module 1010 and reception module 1015 may also be considered an operational pair. It would be similarly understood that transceiver 1055 at site A and transceiver 1060 at site B may be considered to be an operational pair.

FIG. 2(b) shows an exemplary embodiment of the present invention for transmitting TDM signals over an Ethernet installation in one direction. As shown, TDM signals 10 are received along with clock 12 at synchronous data de-serializer/packetizer (TDM data converter/encapsulator) 14, which converts or encapsulates the serial TDM signal data into Ethernet packets. These Ethernet packets are forwarded to transmitting Ethernet switch 18, to be transmitted over the Ethernet installation via port 3 of switch 18. Clock 12, which is received with TDM data 10, is accurate and very stable, as is required in TDM data transmission. Clock 12 also connects to frequency multiplier 16, where its frequency Fᵢ of clock 12 is multiplied by factor n to yield output 34 of a frequency nFᵢ. The multiplication factor n is selected such that nFi is the desired frequency for the Ethernet transmission protocol. Similarly to the example shown earlier, assuming that TDM signal 10 is received in the E1 standard, at a clock frequency of 2.048 MHz, and the desired Ethernet transmission clock is 125 MHz. The frequency Fᵢ of the clock 12 is first divided by a factor p=256 to yield a base frequency Fₘ of 8 KHz, and then multiplied by a factor k=15625, to generate a clock frequency of 125.00 MHz. The overall multiplication factor of multiplier 16 is n=k/p, and the frequency of its output 34 is nFᵢ where Fᵢ is the frequency of its input 12.

Output 34 of frequency multiplier 16 is input to transmitting Ethernet switch 18 as its master clock, thus all the operations in the switch 18 are synchronous to master clock 34, which in turn is a direct derivative of TDM clock 12. As a result, all Ethernet data signals transmitted by switch 18 are synchronous to switch 18 master clock 34, and therefore to TDM clock 12 frequency. Data 24 transmitted by transmitting Ethernet switch 18 is coupled to Physical Media Adapter (PMA) 26, that broadcasts the transmitted data through physical communication media 28 to its destination at receiving PMA 30. Serial Ethernet data 32 received by PMA 30 connects both to port 3 of receiving Ethernet switch 46, and to clock recovery (CR) PLL 36. Clock Recovery PLL 36 locks onto received serial data 32, and generates clock 38, which is synchronous to data 32. Since the serial Ethernet data is generated by switch 18, synchronously with frequency Fᵢ of TDM clock 12, the output frequency of CR PLL 36 is nFᵢ and synchronous with the frequency Fᵢ of TDM clock 12.

Output clock 38 of CR PLL 36, at a frequency of nFᵢ is coupled to frequency divider 40, in which the frequency of clock signal 38 is divided by factor n to yield an output at frequency. Divider 40 is similar in its construction to the multiplier 16, and here as well, the division factor n=k/p. Following the E1 TDM example given above, for Fᵢ=2.048 MHz, and nFᵢ=125.00 MHz, the frequency of clock signal 38 is first divided by the factor p=15625, and then multiplied by the factor of k=256. Synchronous clock 42 is output by clock frequency divider 40.

TDM data transmitted over the Ethernet installation and received by receiving Ethernet switch 46 is output on port 2 of switch 46, which is coupled to serializer 44. Serializer 44 receives the TDM data as Ethernet packets. Serializer 44 parses the packets and converts the TDM data back to synchronous serial data stream 48 with properties as specified for the TDM signals used. Ethernet parallel data 20 and Ethernet parallel clock 22 are input to transmitting Ethernet switch 18. On the receiving side, Ethernet receive data 50 and Ethernet receive clock 52 are output.

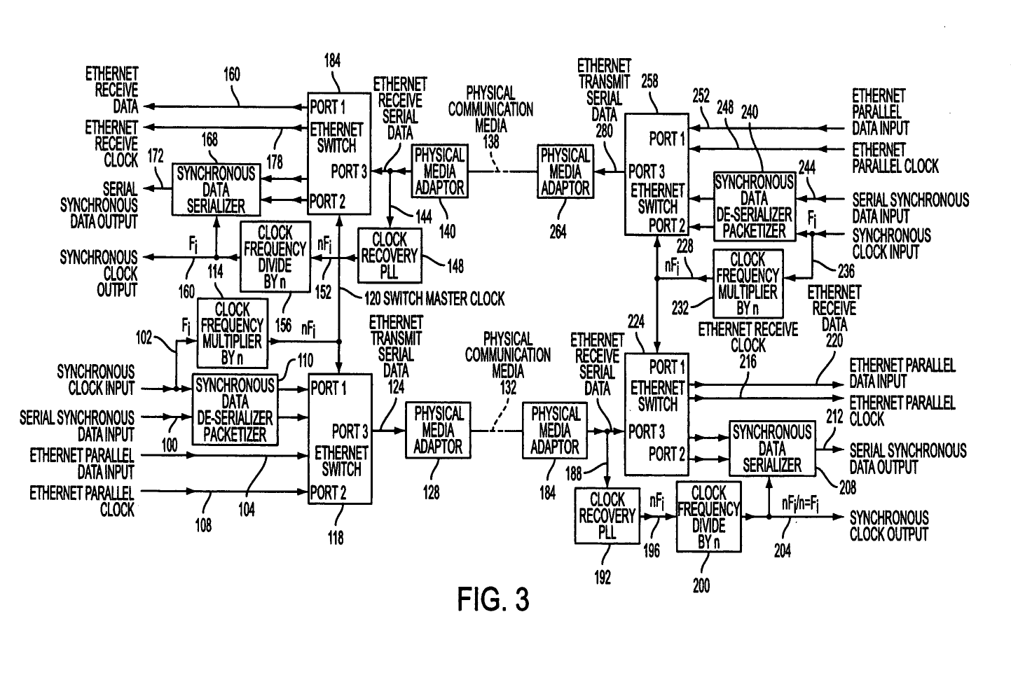

FIG. 3 shows an exemplary embodiment of a system of the invention disposed for bi-directional transmission of TDM signals over Ethernet installations. The bidirectional system is essentially two unidirectional systems similar to the exemplary embodiment shown in FIG. 2. The primary difference between the embodiments FIG. 2 and that of FIG. 3 is in the source of the master clocks for the Ethernet switches 118, 164, and 224, 256. Switch pairs 118 and 164, and 224 and 258, can each be viewed as essentially a bi-directional switch, and thus, each bi-directional switch utilizes a common master clock derived from the local TDM clocks 102 and 236 respectively. Master clock 120 for the bi-directional Ethernet switch comprised of switches 118 and 164, is derived from, and is synchronous to, TDM clock 102. Similarly, master clock 228 for the bi-directional switch comprised of switches 224 and 256, is derived from, and is synchronous to, TDM clock 236.

Ethernet switches 18, 46, 118, 164, 224, and 256, shown in FIGS. 2 and 3, as each having 3 ports, can in any practical embodiment have any number of ports greater than 2 ports. To preserve the frequency of the TDM signals while transported over an Ethernet installation, the clock frequency used in the Ethernet communication link should be derived, by multiplication, from the clock frequency of the TDM signal at the transmitting end. The TDM signal clock at the receiving end should be derived by division from the received Ethernet clock.

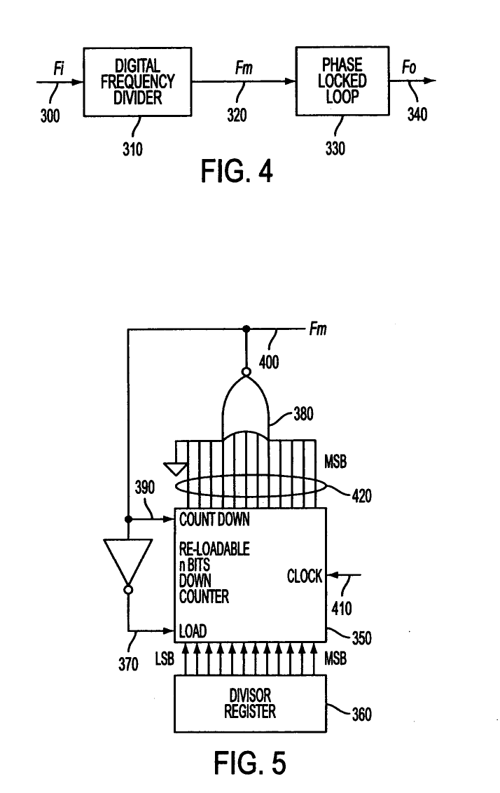

FIG. 4 shows an exemplary embodiment of a frequency multiplier/divider. Frequency Fᵢ of input signal 300 is divided by Digital Frequency Divider (DFD) 310, by a factor of p. The output 320 of the divider 310 is then at a frequency Fₘ, which is connected as a reference input to Phase Locked Loop (PLL) 330. PLL 330 generates an output 340 at an output frequency Fₘ, which equals the frequency of the reference input Fₘ, multiplied by a factor k. As a result the multiplier/divider generates an output frequency

$${F}_{o} = \frac{k}{p} {F}_{i} = n {F}_{i} .$$

FIG. 5 shows an exemplary embodiment of a DFD. Re-loadable digital counter 350 is loaded with data stored in divisor register 360, when load signal 370 is “0”. This condition occurs only when all the output bits of counter 420 are “0”. As soon as counter 350 is loaded with data, output bits 420 are no longer all “0” and, as a result, load signal 370 goes to “1”, and count-down signal 390 goes to “0”, causing the counter to count down one unit on any clock 410 transition. When the counter has counted down to 0 all its output bits 420 become “0”, causing counter 350 to reload and start counting down over again. If the data stored in divisor register 360 is p, in binary form, the counter counts the clock periods modulo p and frequency Fₘ of the output 400 is

$${F}_{m} = \frac{{F}_{i}}{k} .$$

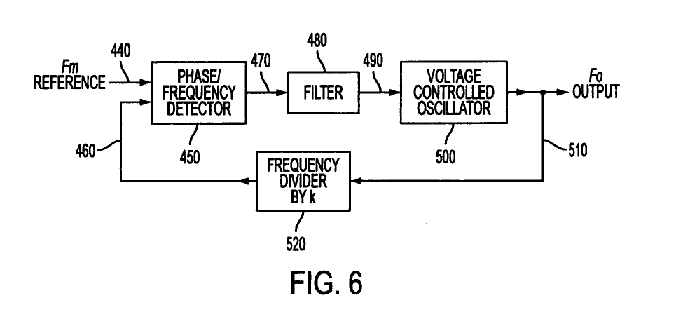

An exemplary embodiment of a PLL is shown in FIG. 6. Phase/frequency detector 450 compares the phase of the reference input 440, with the phase of output 460 of frequency divider 520. Frequency divider 520 is similar to the digital frequency divider shown in FIG. 5. If the phase of reference input 440 is different from the phase of signal 460, phase detector 450 generates an error signal 470, which is filtered by loop filter 480, and applied as a control signal 490 to Voltage Controlled Oscillator (VCO) 500. In response to a change in control signal 490, VCO 500 changes its output frequency. Output 510 of VCO 500 connects to digital frequency divider 520, which divides the frequency Fₒ at output 510 of VCO 500, by a factor of k. As a result, frequency F_{d} at the output 460 of the divider 520 is

$${F}_{d} = \frac{{F}_{o}}{k} .$$

The closed loop is settled when frequency F_{d} at output 460 of divider 520 equals frequency Fₘ at reference input 440, and the phase of signal 460 equals the phase of reference signal 440. Thus, when

$${F}_{d} = \frac{{F}_{o}}{k} .$$

then Fₒ=kF_{d}, and since F_{d}=Fₘ, then Fₒ=kFₘ.

In a PLL, as shown in FIG. 6, output frequency Fᵥ is divided by k, and then compared with reference frequency Fₒ. The PLL adjusts the output frequency Fᵥ such that Fᵥ=k Fₒ. Frequency may be divided using digital counters, as shown in FIG. 5. A counter is loaded with a binary value d, and then set to count down, such that the binary value in the counter is decremented by one count on every clock period. When the binary value in the counter goes down to zero, the counter is reloaded with value d, and the process is repeated. As this process is repeated the counter is counting modulo d, and the most significant bit of the counter goes over a full cycle every d clock periods. Therefore, such a digital counter can be seen as a device which divides the frequency of a clock input signal Fᵢ by a factor d such that the frequency of the output signal Fₛ is Fₛ=Fᵢ/d. Accordingly, it follows that, when Fᵢ=Fᵥ, and k=d, then Fₛ=Fₒ.

The present invention can be adapted to a connection between two Ethernet network as shown in FIGS. 2 and 3 or can be extended to apply to connections between multiple Ethernet networks via network switches provided that the clock used in transmitting data from the network switch is the clock recovered from the data when it is received. Even though data is usually transmitted from a port different from the port on which a packet of data was received, and the time at which a packet is re-transmitted is delayed with respect to the time at which the packet was received, he recovered clock is not interrupted on the receiving port and can be used in the re-transmission. That is, Ethernet signals are transmitted continuously and on every port a clock is continuously being recovered from the received data on the port. In network switches, data received on a port is stored in the network switch while it is being processed.

When processing of the data is complete, the packet of data is transmitted, from a different port, towards its destination. In accordance with the present invention, when a packet of data is stored in a network switch, it is identified with a source port on which it was received. The network switch employs a switching matrix specifically for the clock such that when the packet is transmitted a recovered clock from the receiving port can be routed to the transmitting port to be used as the transmission clock. Thus, in accordance with the present invention the network switches guarantee that a transmitted packet is sent out using the clock derived at the port on which the data was received.

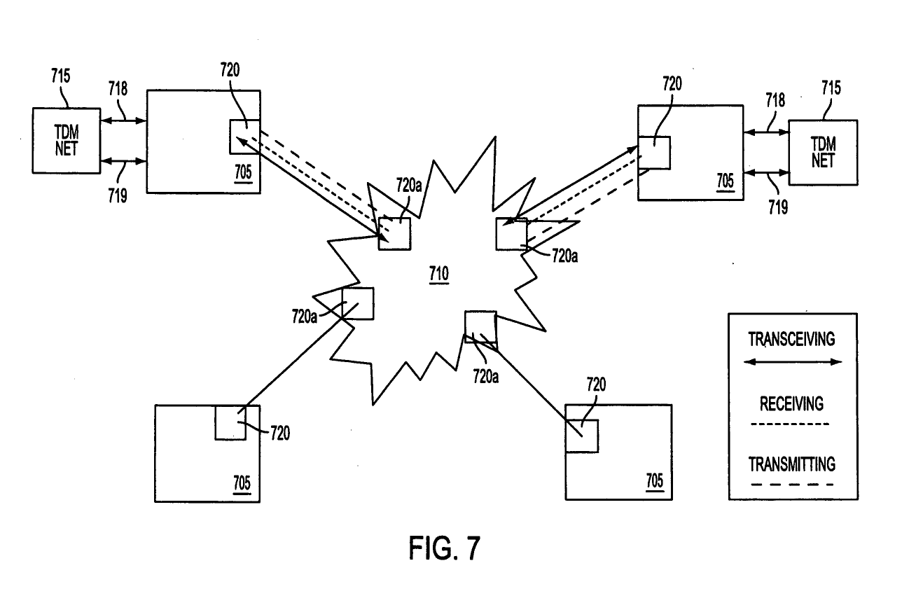

FIG. 7 is a conceptual view of a plurality of Ethernet networks 705 connected via at least one Wide Area Network (WAN) 710. The plurality of Ethernet networks 705 may be connected via a plurality of WANs. The plurality of Ethernet networks 705 may also be connected to one or more TDM networks 715 via WAN 710. Each Ethernet network 720a is connected to the WAN by a network switch 720, such as a router, a bridge or a brouter. There is a corresponding network switch 720a on the WAN side of the connection. In all cases, the network switches 720 and 720a include switching matrices to guarantee that a transmitted packet is sent out using. the clock derived at the port on which the data was received.

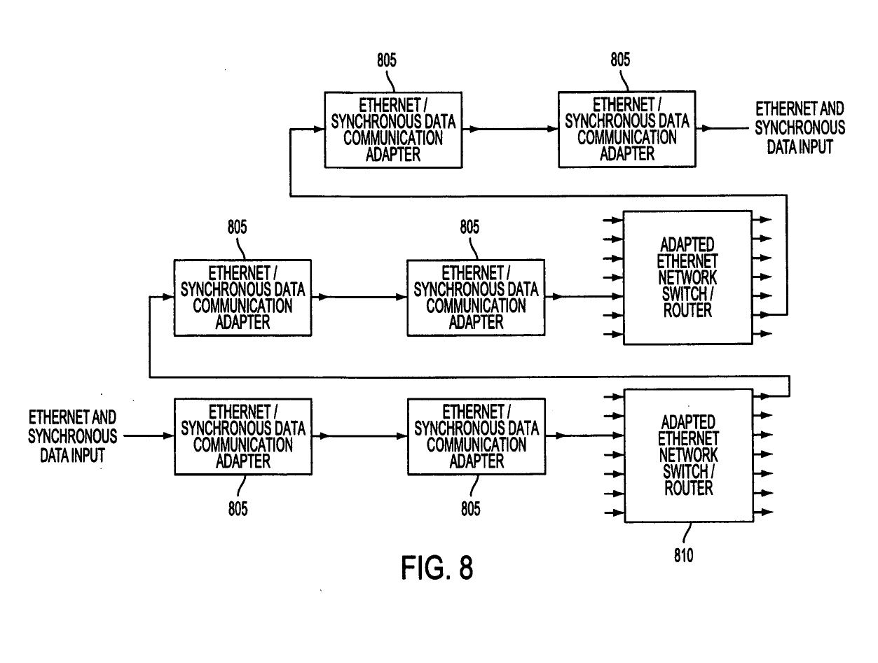

FIG. 8 is a block diagram of the present invention used with network switching devices adapted to perform clock recovery functions between Ethernets. Ethernet/synchronous data communication adapter 805 comprises an exemplary embodiment of the present invention as depicted in FIGS. 2 and 3 for communicating between two Ethernet networks. Modified Ethernet network switch 810 (e.g., router, bridge, brouter) includes adapted network switches 720 and 720a and the interposed WAN 710. The network as depicted in FIG. 8 shows communication between Ethernet networks and over two WANs using modified network switches.

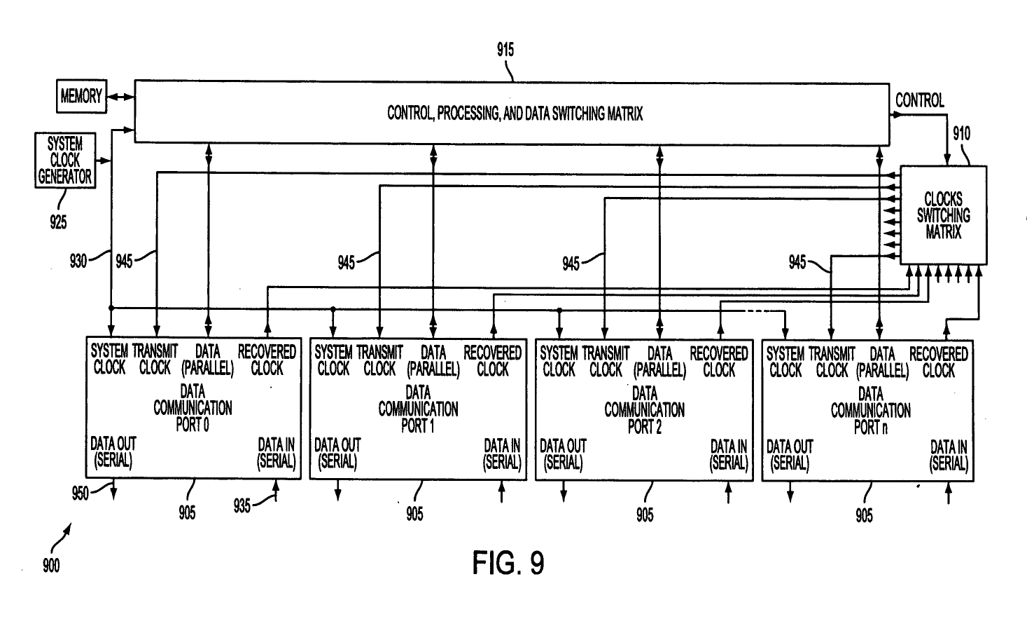

FIG. 9 is a block diagram of an exemplary network switching device of the present invention. Each data communication port 905 of the network switch 900 is coupled to a system clock 930 generated by system clock generator 925. A clock is recovered from data 935 received at a given data communication port 905. Data is forwarded to a data control, switching and processing matrix 915 for processing. Each recovered clock is forwarded to clock switching matrix 910. When an output port is selected for the data then the clock switching matrix forwards the recovered clock for the given data to the output data communications port 905 to be used as the transmit clock 945 for transmit data 950.

Within the scope and spirit of the invention, the terms “act” or “acts” are used to mean to take the action or to accomplish, or to take the steps or effect the functions performed by the various embodiments of the invention in order to practice, effect or perform the disclosed process. For example, the acts of receiving, generating, packetizing, switching and forwarding can also be understood as performed steps or functions and, as such, these terms are descriptive and not limiting. As one of skill in the art can appreciate, the possible architectures of the present invention, that is, how the components of systems according to the invention may be connected to and operate with one another, may be varied to provide one or more systems that are adapted, or adaptable to, a myriad of specifications. The transmission, reception and transceiver modules of the present invention thus may be designed to support voice, video, data and text communications.

1. A transmission module for transmitting Time Division Multiplexed (“TDM”) data over an Ethernet network comprising:
i) a TDM data converter/encapsulator for receiving TDM data from a source;
ii) a synchronous clock signal associated with said TDM data;
iii) a clock frequency multiplier coupled to said TDM data converter/ encapsulator;
iv) a switch for receiving converted/encapsulated TDM data and for receiving a master clock signal; and
v) wherein said master clock signal is generated by said clock frequency multiplier, said master clock signal being related to said synchronous clock signal associated with said TDM data;
wherein said switch is coupled to both
a) said TDM data converter/encapsulator, and
b) said clock frequency multiplier.

2. The transmission module of claim 1, wherein said switch comprises at least two ports, and wherein said master clock signal governs and synchronizes the timing of data transmissions from said switch.

3. The transmission module of claim 1, wherein said clock frequency multiplier has an input frequency, an output frequency, and a frequency multiplication ratio which is the ratio of said input and output frequencies, and wherein said clock frequency multiplier is adapted and arranged such that said output frequency is a multiple of said input frequency.

4. The transmission module of claim 3, wherein said output frequency equals said master clock frequency.

5. The transmission module of claim 1, wherein one or more of said input frequency, said output frequency, and said frequency multiplication ratio are digitally programmable.

6. A reception module for receiving converted/encapsulated Time Division Multiplexed (“TDM”) data over an Ethernet network comprising:
i) a switch for receiving said converted/encapsulated TDM data from said Ethernet network over at least one Ethernet communications medium;
ii) a TDM decapsulator coupled to said switch;
iii) a clock recovery phase locked loop (“PLL”) for receiving a frequency, said PLL being adapted to adjust a phase of said frequency to provide a phase-adjusted frequency; and
iv) a clock frequency divider coupled to said PLL for dividing said phase-adjusted frequency to recover a TDM clock signal associated with said TDM data.

7. The module of claim 6, wherein said TDM decapsulator is
a) coupled to said clock frequency divider, and
b) adapted and arranged to serialize said received converted/encapsulated TDM data by means of said recovered TDM clock signal.

8. The module of claim 6, wherein said converted/encapsulated TDM data is received as Ethernet packets and said Ethernet packets are converted into at least one TDM protocol data stream.

9. The module of claim 6, wherein said switch comprises at least two ports.

10. The module of claim 6, further comprising
ix) a master clock signal which is adapted and arranged to govern and synchronize the timing of data received via said switch.

11. The module according to claim 6, wherein said clock recovery PLL extracts a high frequency clock signal from said received Ethernet data and said extracted frequency clock signal equals the data bit rate of said received TDM data.

12. The module according to claim 6, wherein said clock frequency divider has an input frequency, an output frequency, and a frequency division ratio which is the ratio of said input and output frequencies, and wherein said divider is adapted and arranged such that said output frequency is a fraction of said input frequency.

13. The module according to claim 12, wherein said output frequency equals said received TDM clock signal.

14. The module of claim 12, wherein one or more of said input frequency, said output frequency, and said frequency division ratio are digitally programmable.

15. A system for communicating Time Division Multiplexed data over an Ethernet network, said system comprising at least one transmission module and at least one reception module,
wherein said at least one transmission module comprises
i) a TDM data converter/encapsulator for receiving TDM data from a source;
ii) a synchronous clock signal associated with said TDM data;
iii) a clock frequency multiplier coupled to said TDM data converter/encapsulator; and
iv) a first switch for receiving converted/encapsulated TDM data and for receiving a master clock signal;
wherein said master clock signal is generated by said clock frequency multiplier, said master clock signal being related to said synchronous clock signal associated with said TDM data; and
wherein said first switch is coupled to both
a) said TDM data converter/encapsulator, and
b) said clock frequency multiplier; and
wherein said at least one reception module comprises
v) a second switch for receiving converted/encapsulated TDM data from said Ethernet network over at least one Ethernet communications medium;
vi) a TDM decapsulator coupled to said second switch;
vii) a clock recovery PLL for receiving a frequency, said PLL being adapted to adjust a phase of said frequency to provide a phase-adjusted frequency; and
viii) a clock frequency divider coupled to said PLL for dividing said phase-adjusted frequency to recover a TDM clock signal associated with said TDM data;
wherein said TDM decapsulator is a) coupled to said clock frequency divider, and b) adapted and arranged to serialize said received converted/encapsulated TDM data by means of said recovered TDM clock signal.

16. The system of claim 15, wherein said at least one transmission module and said at least one reception module are located distant from one another and are adapted and arranged to function as a first operational pair for communicating data in a first direction.

17. The system of claim 16, further comprising a second reception module and a second transmission module,
wherein said second transmission module and said second reception module are operationally adapted and arranged to function as a second operational pair,
and wherein said first and second operational pairs are adapted and arranged to function as a bidirectional communications system for communicating in said first direction and in a second direction, said second direction being opposite said first direction.

18. The system of claim 17, wherein said at least one transmission module and said second reception module are co-located with one another to comprise a first transceiver module.

19. The system of claim 17, wherein said at least one reception module and said second transmission module are co-located with one another to form a second transceiver module.

20. The system of claim 17, wherein at least one reception module and at least one transmission module are co-located to form a transceiver module.

21. The system of claim 17, comprising a plurality of transceiver modules operationally coupled, adapted and arranged to form a network.

22. The system of claim 15, wherein said transmission module comprises at least two ports, and wherein said master clock governs and synchronizes the timing of data transmissions from each of said ports.

23. The system of claim 15, wherein said reception module comprises at least two ports, and wherein said master clock governs and synchronizes timing of data transmissions from said ports.

24. The system of claim 15, wherein said clock frequency multiplier has an input frequency, an output frequency, and a frequency multiplication ratio which is the ratio of said input and output frequencies, and wherein said multiplier is adapted and arranged such that said output frequency is a multiple of said input frequency.

25. The system of claim 24, wherein one or more of said input frequency, said output frequency, and said frequency multiplication ratio are digitally programmable.

26. The system of claim 15, wherein said converted/encapsulated TDM data is received as Ethernet packets and said Ethernet packets are converted into at least one TDM protocol data stream by said TDM decapsulator.

27. The system according to claim 16, wherein said clock recovery PLL extracts a high frequency clock signal from said received Ethernet data and said extracted frequency clock equals the data bit rate of said received TDM data.

28. The apparatus according to claim 15, wherein said clock frequency divider has an input frequency, an output frequency, and a frequency division ratio which is the ratio of said input and output frequencies, and wherein said clock frequency divider is adapted and arranged such that said output frequency is a fraction of said input frequency.

29. A method for transmitting Time Division Multiplexed (“TDM”) data over an Ethernet network comprising the acts of
i) receiving said TDM data and a synchronous clock associated with said TDM data from a source by means of a TDM data converter/encapsulator;
ii) generating a master clock signal related to said synchronous clock signal,
iii) packetizing said TDM data,
iv) forwarding said packetized data and said master clock signal to a switch; and
v) switching said packetized TDM data onto at least one Ethernet communications media of said Ethernet network.

30. The method of claim 29, wherein said master clock signal is generated by said clock frequency multiplier, and said master clock is related to said synchronous clock signal associated with said TDM data, and wherein said switching is effected by a switch which is coupled to both said TDM data converter/encapsulator, and to said clock frequency multiplier.

31. The method of claim 29, wherein said acts iii and iv are performed concurrently.

32. The method of claim 29, wherein said switch comprises at least two ports, and wherein said master clock signal governs and synchronizes the timing of data transmissions from said switch.

33. The method of claim 29, wherein said clock frequency multiplier has an input frequency, an output frequency, and a frequency multiplication ratio which is equal to the ratio of said input and output frequencies, and wherein said multiplier is adapted and arranged such that said output frequency is a multiple of said input frequency.

34. The method of claim 29, wherein said output frequency equals said master clock frequency

35. The method of claim 34, wherein one or more of said input frequency, said output frequency, and said frequency multiplication ratio are digitally programmable.

36. A method for receiving converted/encapsulated Time Division Multiplexed (“TDM”) data over an Ethernet network comprising the acts of:
i) receiving said converted/encapsulated TDM data from said Ethernet network by means of a switch;
ii) decapsulating said TDM data by means of a TDM decapsulator coupled to said switch;
iii) receiving a clock frequency signal by means of a clock recovery PLL;
iv) adjusting said clock frequency signal by means of said clock recovery PLL to provide a phase-adjusted clock frequency, said PLL being adapted to adjust a phase of said clock frequency signal; and
v) dividing said phase-adjusted clock frequency by means of a clock frequency divider coupled to said PLL to recover a TDM clock signal associated with said TDM data.

37. The method of claim 36, wherein said TDM decapsulator is
a) coupled to said clock frequency divider, and
b) adapted and arranged to serialize said received converted/ encapsulated TDM data by means of said recovered TDM clock signal.

38. The method of claim 36, wherein said converted/encapsulated TDM data is received as Ethernet packets and said Ethernet packets are converted into at least one TDM protocol data stream.

39. The method of claim 36, wherein said acts iii and iv are performed concurrently.

40. The method of claim 36, wherein said switch comprises at least two ports, and wherein said master clock signal governs and synchronizes the timing of data transmissions from said switch.

41. The method of claim 36, wherein said clock frequency divider has an input frequency, an output frequency, and a frequency division ratio which is equal to the ratio of said input and output frequencies, and wherein said divider is adapted and arranged such that said output frequency is a fraction of said input frequency.

42. The method of claim 36, wherein said output frequency equals said master clock frequency.

43. The method of claim 36, wherein one or more. of said input frequency, said output frequency, and said frequency division ratio are programmable.

44. A method for communicating Time Division Multiplexed data over an Ethernet network, said method comprising the act of
I) providing at least two transceiver modules, and
II) operationally coupling, adapting or arranging said at least two transceiver modules to effect communication therebetween.

45. The method of claim 44, wherein each of said transceiver modules comprises
A) at least one transmission module and B) at least one reception module, wherein each said at least one transmission module comprises
i) a TDM data converter/encapsulator for receiving TDM data from a source;
ii) a synchronous clock signal associated with said TDM data;
iii) a clock frequency multiplier coupled to said TDM data converter/encapsulator; and
iv) a first switch for receiving converted/encapsulated TDM data and for receiving a master clock signal;
wherein said master clock signal is generated by said clock frequency multiplier, said master clock signal being related to said synchronous clock signal associated with said TDM data; and
wherein said first switch is coupled to both
a) said TDM data converter/encapsulator, and
b) said clock frequency multiplier; and
wherein each said at least one reception module comprises
v) a second switch for receiving converted/encapsulated TDM data from said Ethernet network over at least one Ethernet communications medium;
vi) a TDM decapsulator coupled to said second switch;
vii) a clock recovery PLL for receiving a frequency, said PLL being adapted to adjust a phase of said frequency to provide a phase-adjusted frequency; and
viii) a clock frequency divider coupled to said PLL for dividing said phase-adjusted frequency to recover a TDM clock signal associated with said TDM data;
wherein said TDM decapsulator is a) coupled to said clock frequency divider, and b) adapted and arranged to serialize said received converted/encapsulated TDM data by means of said recovered TDM clock signal.

46. The method of claim 44, comprising the further acts of
III) providing more than two of said transceiver modules, and
IV) operationally coupling, adapting or arranging said more than two transceiver modules to effect communication or among any two or more of said modules.

47. A network comprising:
A) a first Ethernet network and a second Ethernet network, wherein each of said Ethernet networks is adapted for bi-directional communications between a transmission module and a reception module of each of said Ethernet networks,
B) at least one wide area network (WAN) adapted for long-distance bi-directional communications, said wide area network being interposed between said first and said second Ethernet networks, and
C) a plurality of operational pairs of switches adapted for performing clock recovery functions and data transfer functions between pairs of Ethernet networks,
wherein said first Ethernet network and said second Ethernet network are adapted to communicate with one another through said wide area network.

48. The network of claim 47, wherein each of said first and second Ethernet networks comprises at least one transmission module, and at least one reception module.

49. The network of claim 47, wherein each of said Ethernet transmission modules comprises
i) a TDM data converter/encapsulator for receiving TDM data from a source;
ii) a synchronous clock signal associated with said TDM data;
iii) a clock frequency multiplier coupled to said TDM data converter/encapsulator; and
iv) a transmission module switch for receiving converted/encapsulated TDM data and for receiving a master clock signal;
wherein said master clock signal is generated by said clock frequency multiplier, said master clock signal being related to said synchronous clock signal associated with said TDM data; and
wherein said transmission module switch is coupled to both
a) said TDM data converter/encapsulator, and
b) said clock frequency multiplier; and
wherein each of said Ethernet reception modules comprises:
v) a reception module switch for receiving converted/encapsulated TDM data from said Ethernet network over at least one Ethernet communications medium;
vi) a TDM decapsulator coupled to said second switch;
vii) a clock recovery PLL for receiving a frequency, said PLL being adapted to adjust a phase of said frequency to provide a phase-adjusted frequency; and
viii) a clock frequency divider coupled to said PLL for dividing said phase-adjusted frequency to recover a TDM clock signal associated with said TDM data;
wherein said TDM decapsulator is a) coupled to said clock frequency divider, and b) adapted and arranged to serialize said received converted/encapsulated TDM data by means of said recovered TDM clock signal.

50. The network of claim 47, wherein each of said operational pairs of switches is adapted and configured between one of said Ethernet networks and said WAN to function as a transceiver switch pair.

51. The network of claim 48, wherein said at least one Ethernet reception module and said at least one Ethernet transmission module are adapted or configured to form a single operational transceiver module.

52. The network of claim 47, wherein a first pair of said plurality of operational pairs of switches is configured as a transmission switch pair such that
i) a first switch of said transmission switch pair accepts encapsulated Ethernet data from one of said at least two Ethernet networks for transmission to a second switch of said transmission switch pair, and
ii) said second switch of said transmission switch pair transmits said encapsulated Ethernet data and interfaces with said WAN to transmit said encapsulated Ethernet data over said WAN to a second pair of said plurality of pairs of switches,
and wherein said second pair of said plurality of switches is configured as a reception switch pair such that,
iii) a first switch of said reception switch pair receives said encapsulated Ethernet data via said WAN, and
iv) a second switch of said reception switch pair receives said encapsulated Ethernet data from said first switch of said reception switch pair for forwarding and distribution over a second of said at least two Ethernet networks.

53. The network of claim 52, further comprising a plurality of said Ethernet networks and a plurality of said operational switch pairs.

54. The network of claim 47, further comprising at least one TDM network, wherein said TDM network is adapted and configured to communicate with at least one of said Ethernet networks.

55. The network of claim 52, wherein said first pair of said plurality of operational pairs of switches is configured both as a transmission switch pair and a reception switch pair to form a transceiver switch pair for bidirectional communications.

56. The network of claim 55, wherein said operational pairs of switches are implemented to form an adapted network switch.

57. A method for communicating TDM data over long distances comprising the acts of:
A) providing at least a first Ethernet network and a second Ethernet network, wherein each of said Ethernet networks is adapted for bi-directional communications between a transmission module and a reception module of each of said Ethernet networks,
B) providing at least one wide area network (WAN) adapted for long-distance bi-directional communications, said wide area network being interposed between said first and said second Ethernet networks, and
C) providing a plurality of operational pairs of switches adapted for performing clock recovery functions and data transfer functions between pairs of Ethernet networks,
wherein said first Ethernet network and said second Ethernet network are adapted to communicate with one another through said wide area network.

58. The method of claim 57, wherein a first pair of said plurality of operational pairs of switches is configured as a transmission switch pair such that
i) a first switch of said transmission switch pair accepts encapsulated Ethernet data from one of said at least two Ethernet networks for transmission to a second switch of said transmission switch pair, and
ii) said second switch of said transmission switch pair transmits said encapsulated Ethernet data and interfaces with said WAN to transmit said encapsulated Ethernet data over said WAN to a second pair of said plurality of pairs of switches,
and wherein said second pair of said plurality of switches is configured as a reception switch pair such that,
iii) a first switch of said reception switch pair receives said encapsulated Ethernet data via said WAN, and
iv) a second switch of said reception switch pair receives said encapsulated Ethernet data from said first switch of said reception switch pair for forwarding and distribution over a second of said at least two Ethernet networks.

59. The method of claim 57, wherein said method is effected over a plurality of said Ethernet networks and a plurality of said operational switch pairs.

60. The method of claim 59, wherein said method is effected over at least one TDM network, wherein said TDM network is adapted and configured to communicate with at least one of said Ethernet networks.

61. A method for communicating TDM data over long distances, comprising the acts of:
A. providing TDM data and a synchronized clock signal from a first TDM network to a first Ethernet network;
B. encapsulating said TDM data;
C. generating a master clock signal related to said synchronous clock signal by means of a frequency multiplier;
D. forwarding said encapsulated TDM data to a first operational pair pair;
E. forwarding said encapsulated TDM data to a second operational switch pair via a wide area network;
F. receiving said encapsulated TDM data at a destination in a second Ethernet network;
G. decapsulating said received encapsulated TDM data;
H. recovering and phase-adjusting a clock signal from said decapsulated TDM data using a phase-locked loop and a frequency divider;
I. serializing said decapsulated TDM data; and
J. forwarding said serialized TDM data and said recovered clock signal to a second TDM network.

62. An adapted network switch comprising:
i) a system clock generator;
ii) a control, processing and data switching matrix coupled to memory, said control, processing and data switching matrix further coupled to said system clock generator;
iii) a plurality of data communication ports coupled to said system clock generator, each of said ports further coupled to said control, processing and data switching matrix via bidirectional data signals; and
iv) a clock switching matrix coupled to said control, processing and data switching matrix via a control signal, said clock switching matrix configured such that a clock used in transmitting data from said adapted network switch is the clock recovered from the data when said data was received at said data communications port.
